(19) United States
(12) Patent Application Publication
(10) Pub. No.: US 2003/0065239 A1
(43) Pub. Date: Apr. 3, 2003

(54) Non-hazardous basic neutralization of aldehydes

(76) Inventors: Peter Zhu, Irvine, CA (US); Charles G. Roberts, Long Beach, CA (US); Harriet Chan-Myers, Lake Forest, CA (US)

Correspondence Address: AUDLEY A. CIAMPORCERO JR., JOHNSON & JOHNSON, ONE JOHNSON & JOHNSON PLAZA, NEW BRUNSWICK, NJ, 08933-7003, US

(21) Appl. No.: 09/896,589

(22) Filed: Jun. 29, 2001

(51) Int. Cl. A62D 3/00

(52) U.S. Cl. 588/242

(57) ABSTRACT

Methods and systems for alleviating the problems of toxic discharge of aldehydes present in waste streams are disclosed. The methods relate to forming neutralized aldehydes by treating aldehydes with basic compounds. The use of bases offers a simple, effective and inexpensive solution for treatment of toxic aldehydes prior to disposal into the environment.

### RELATED APPLICATIONS

This patent application is related to concurrently filed and commonly assigned patent application U.S. Ser. No. ______, filed Jun. 29, 2001 entitled “NON-HAZARDOUS OXIDATIVE NEUTRALIZATION OF ALDEHYDES” (Attorney Doc. No. ASP-0029), the disclosure of which is incorporated by reference.

### BACKGROUND OF THE INVENTION

1. Field of the Invention

The invention relates to neutralization of aldehydes for the purpose of complying with waste disposal requirements established by federal and state environmental protection agencies, in particular, with forming non-reversible neutralized aldehydes which are non-hazardous and do not revert back to toxic aldehydes.

2. Description of Related Art

Waste disposal of aldehydes has become increasingly more difficult over the years. Treatment of wastes containing a certain amount of aldehyde prior to placement of the waste into the environment is required by law. The extent of such treatment may vary depending upon the location of where the waste is generated and the stringency of the environmental standards in that area. For example, waste containing aldehyde may be classified as a hazardous waste in California under 22 CAL. CODE REGS., TIT. 22, §66696. Formaldehyde also may be considered a hazardous waste on the federal level under 40 C.F.R. §261.33(e) if it is a commercial chemical product (e.g, pure technical grade formaldehyde or formaldehyde is the sole active ingredient of the product that is to be disposed). Every state has an environmental regulation that is at least as stringent as this formaldehyde standard. State regulations also may be more stringent than this standard.

Additionally, facilities that discharge waste water to Publicly Owned Treatment Works (“POTW”) or directly into navigable waters may be required to meet standards that are established by a government agency. The standard may vary for each facility depending upon the quality of the receiving water and the concentration of aldehyde found in the waste water that is discharged into the environment by industry in that area.

Waste containing aldehyde may be generated by a variety of processes. For example, aldehydes such as glutaraldehyde and o-phthalaldehyde (“OPA”) are used in disinfecting medical devices or instruments. Waste containing aldehydes also may be generated by painting operations, stripping operations related to floors, or other manufacturing operations.

Typically, ammonia and sodium bisulfite (“SBS”) are used to treat many aldehydes. These compounds, however, have not proven to be effective at neutralizing OPA in accordance with environmental regulations.

A waste is classified as a hazardous waste in California if the waste being examined “has an acute aquatic 96-hour LC₅₀ less than 500 milligrams per liter (mg/L) when measured in soft water (total hardness 40 to 48 milligrams per liter of calcium carbonate) with fathead minnows . . . ” 22 CAL. CODE REGS., TIT. 22, §66696. Thus, LC₅₀ represents the concentration of a waste that is necessary to kill 50% of a particular animal exposed to a waste.

Note that a nonhazardous waste is generally considered by federal and state environmental agencies as a waste that does not satisfy the criteria set forth in defining a hazardous waste. Therefore, wastes generated in California that have a LC₅₀>500 mg/L are nonhazardous wastes and wastes having LC₅₀<500 mg/L are classified as hazardous. SBS, for example, in combination with OPA, produces a product that is generally considered hazardous under California environmental law as shown in Table 1 by LC₅₀ being consistently below 500 mg/L. For this study, CIDEX® OPA (commercially available from Advanced Sterilization Products®, a Johnson & Johnson Company of Irvine, Calif.) was used to supply the OPA.

TABLE 1
Neutralization Of OPA Using SBS

| Sample Type | OPA Content (%) | LC₅₀ (mg/L) | Comments |
|---|---|---|---|
| Fresh CIDEX ® OPA at | 0.301% | 31.1 mg/L | 1 |
| 0.3% OPA | | | |
| Fresh CIDEX ® OPA at | 0.158% | 50.4 mg/L | 2 |
| 0.15% OPA | | | |
| Reuse CIDEX ® OPA at | 0.295% | 31.1 mg/L | 3 |
| 0.3% OPA | | | |
| SBS/OPA = 4:1 | N/A | 68.3 mg/L | 4 |
| SBS/OPA = 2:1 | N/A | 46.3 mg/L | 5 |

1. Fresh CIDEX ® OPA at 0.3% OPA was prepared by diluting the fresh Cidex OPA solution with deionized water.
2. Fresh CIDEX ® OPA at 0.15% OPA was prepared by diluting the fresh Cidex OPA solution with deionized water to the level of 0.15% of OPA.
3. Reuse of CIDEX ® OPA at 0.3% OPA was prepared by diluting the simulated reuse CIDEX ® OPA (14 days) with deionized water.
4. SBS/OPA = 4:1, 10% SBS (10 mL) was combined with 100 mL of the fresh CIDEX ® OPA solution at 0.3% OPA (sample 1 above) at the SBS/OPA molar ratio of 4 to 1 for 30 minutes, and then the combined solution was used in the 22 CAL. CODE REGS., TIT. 22, § 66696 test for California.
5. SBS/OPA = 2:1, 10% SBS (5 mL) was combined with or 100 mL of the fresh CIDEX ® OPA solution at 0.3% OPA (sample 1 above) at the SBS/OPA molar ratio of 2 to 1 for 30 minutes, and then the combined solution was used for the fish test in the 22 CAL. CODE REGS., TIT. 22, § 66696 test for California.

In addition to lacking the ability to effectively neutralize OPA, ammonia and SBS are problematic since they may be harmful to the environment.

FIG. 1 shows that when OPA is combined with SBS at the molar ratio of SBS/OPA=4:0 for 30 minutes, OPA has been neutralized since the OPA concentration is nondetectable in a high performance liquid chromatography (HPLC) analysis method, which has detection limit for OPA at 10 ppm. However, the end product is still classified as a hazardous waste as shown in Table 1. Therefore, even though the aldehyde is neutralized completely by a neutralizer, the end product may still be a hazardous waste.

The purpose of this invention is to invent an effective, non-hazardous, convenient and inexpensive neutralizer for OPA and/or other α-hydrogen-free aldehydes. OPA is one of the main chemicals used in industry and hospital for high-level disinfection. The OPA needs to be neutralized after use and before disposal, however, at this point, there are only very limited neutralization methods available. Commonly assigned patent application U.S. Ser. No. 09/321,964, entitled “ALDEHYDE NEUTRALIZER” suggests using amino acids such as glycine as neutralizers. While use of glycine offers an inexpensive and non-hazardous solution to aldehyde neutralization, there are, however, some problems with the amino acid neutralizer approach. One problem is that Schiff's base solutions formed between o-phthalaldehyde and glycine is black. In Japan, the general feeling is that they do not like black color; therefore, hospitals send their used solution to the waste treatment companies for disposal, which is expensive. Another approach to the problem of aldehyde neutralization is offered by commonly assigned and co-pending patent application U.S. Ser. No. 09/747,230 entitled “REDUCTIVE AMINATION FOR ALDEHYDE NEUTRALIZATION” which teaches the reaction of aldehydes with amino acid neutralizers followed by reduction of the resulting imines to form amino acids as final environmentally friendly products. This method is best carried out on solid supports and the solid waste is disposed after application. In another approach, commonly assigned and copending patent application U.S. Ser. No. 09/746,344, entitled, “DEVICE AND METHOD OF USE FOR ALDEHYDE REMOVAL”, discloses using polymeric amines as scavengers to remove aldehydes from waste solutions. Although this method removes both glutaraldehyde and o-phthalaldehyde from the used disinfectant solution, the solid waste still must be handled separately.

Thus different approaches to the challenge of aldehyde neutralization are still needed for various situations. This invention is intended to offer another approach relating to neutralization of aldehydes as hereinafter described.

### SUMMARY OF THE INVENTION

One embodiment of this invention relates to a method for making a neutralized aldehyde of lessened toxicity comprising the steps of:

a) providing an α-hydrogen-free aldehyde ; and

b) contacting the aldehyde with an effective amount of a base to render the treated aldehyde as neutralized and less toxic compared with the untreated aldehyde.

Another embodiment of the invention relates to a system for neutralizing an aldehyde without α-hydrogen and making the aldehydes less toxic comprising:

a container;

a source of α-hydrogen-free aldehyde selected from the group consisting of o-phthalaldehyde, formaldehyde and mixtures thereof directed to the container; and

a source of a base directed to the container to yield treated aldehydes of lower toxicity than the untreated aldehydes.

A major advantage of this invention is that it is a simple, inexpensive, and non-hazardous method to neutralize aldehyde sterilization solutions. The end product of basic treatment of aldehydes are either colorless or lightly colored as opposed to some of the dark colored products formed by amino acid neutralization of aldehydes as explained above.

Additional features, embodiments, and benefits will be evident in view of the figures and detailed description presented below.

### BRIEF DESCRIPTION OF THE DRAWINGS

The features, aspects, and advantages of the invention will become more thoroughly apparent from the following detailed description, appended claims, and accompanying drawings in which:

FIG. 1 shows the ratio of SBS:OPA and the concentration of OPA remaining in solution after 30 minutes from combining the ingredients.

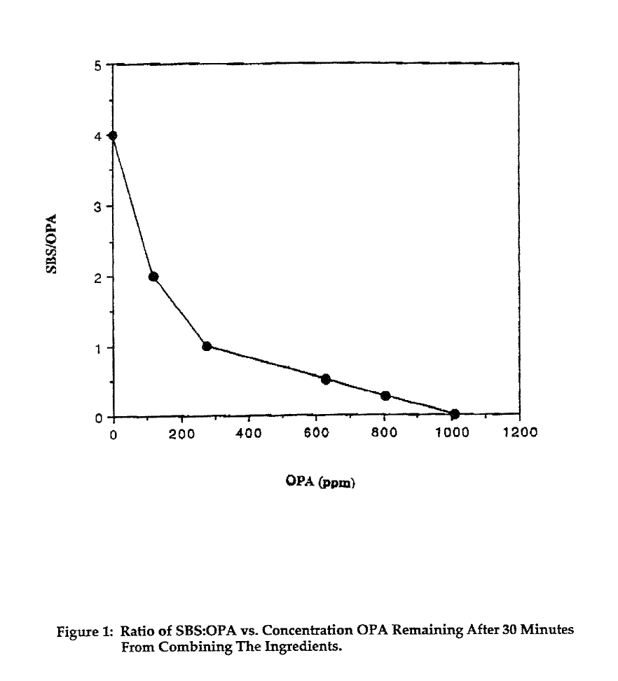

### DETAILED DESCRIPTION OF THE INVENTION

The invention relates to methods and compositions particularly useful for the environmentally friendly and non-reversible neutralization of aldehydes present in waste generated from sterilizing medical devices (e.g., scalpels, scissors, endoscopes, etc.) or laboratory equipment (e.g., glassware) that have been exposed to microorganisms such as bacteria. As used herein, the term non-reversible is intended to refer to the substantial prevention of the neutralized aldehyde (e.g., amino acid treated aldehyde) from reverting back to the starting or unneutralized aldehyde. Sterilizing includes disinfecting medical devices.

Neutralization of aldehydes by bases work with aldehydes that do not contain an α-hydrogen. A Cannizzaro reaction is a base-affected disproportionation of two moles of aldehyde without α-hydrogen to give an alcohol and an acid (Cannizzaro, S. Ann., 88, 129, 1853). Aromatic aldehydes fall into the category of aldehydes without α-hydrogen and OPA is a good example of an aromatic di-aldehyde without α-hydrogen. It is not obvious that if this chemistry could be used for our neutralization purpose. For example, for a close analogue of OPA, benzaldehyde needs to be heated with hydroxide ion to undergo Cannizzaro reaction as shown below.

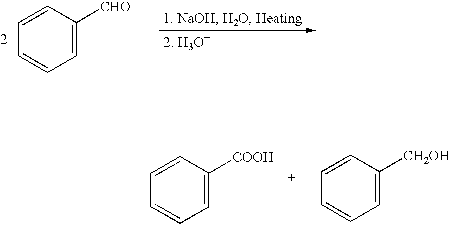

Heating is not desirable in the hospitals. Another concern is the two adjacent aldehyde groups on the benzene ring may complicate and prevent the reaction at mild condition such as at room temperature. However, as disclosed hereinafter, use of OPA is preferred and offers the unexpected advantage of not requiring heating to be neutralized by NaOH since neutralization of OPA by NaOH is accomplished at room temperature.

The neutralizer comprises a basic compound or a precursor to a basic compound that forms a basic compound in-situ prior or during the neutralization process.

Examples of basic compounds are those compounds which contain at least one hydroxide group. Suitable basic compounds are selected from the group consisting of sodium hydroxide, potassium hydroxide, calcium hydroxide, lithium hydroxide, magnesium hydroxide, ferric hydroxide, aluminum hydroxide and mixtures thereof.

Examples of precursors to basic compounds include those which form a hydroxide compound when exposed or introduced to water. Suitable precursor compounds include compounds selected from the group consisting of metallic lithium, metallic sodium, metallic potassium, metallic magnesium, metallic calcium, sodium hydride, potassium hydride, magnesium hydride, calcium hydride, lithium hydride, sodium methoxide, sodium ethoxide, potassium methoxide, potassium ethoxide and mixtures thereof.

When the basic compound is used in solution form, suitable solvents comprise water and alcohol. Suitable alcohols may include methanol, ethanol, isopropanol, n-propanol, and butanols. Water or alcohol may also contain acetone, acetonitrile, or tetrahydrofuran (THF).

Bases are an improvement over the typical chemicals such as ammonia or sodium bisulfite used to neutralize aldehydes since the bases effectively neutralize aldehydes to a level prescribed by federal and state environmental agencies. Effective amounts of the base to the aldehydes will vary based on the aldehyde being neutralized and the base used.

In the case of o-phthalaldehyde as the aldehyde and NaOH as the base, nonhazardous neutralization will occur when the molar ratio range of NaOH to o-phthalaldehyde is typically at least about 2.4:1, typically from about 2.4:1 to 100:1; preferably from 3:1 to 20:1, more preferably from 4:1 to 15:1; and most preferably from 5:1 to 10:1.

The neutralization of the aldehyde solution with NaOH may have a high pH, which may have an adverse effect to the environment. Therefore, depending on the pH of the neutralized solution, proper adjustment of the pH may be needed.

Adjustment of the pH of the neutralized aldehyde may be accomplished by adding water, buffer, an acid or an acid salt of an amino acid to the neutralized aldehyde solution. The acid may be an organic or inorganic acid. Examples of suitable organic acids include amino acids, formic acid, acetic acid, propionic acid, butyric acid, benzoic acid, and mixtures thereof. Examples of suitable inorganic acids include hydrochloric acid, sulfuric acid, phosphoric acid, potassium dihydrogen phosphate, nitric acid and mixtures thereof Examples of suitable acid salts of amino acids include glycine hydrochloride, glycine bisulfate, histidine monohydrochloride, histidine dihydrochloride, lysine dihydrochloride, lysine sulfate, or any other amino acid hydrochloride and mixtures thereof An amino acid could be any essential amino acid or its derivatives.

To neutralize aldehydes, the basic compound in solution or in solid form may be added to waste water that is in a tank (e.g., a neutralization tank at a waste water treatment plant), or in a small container (e.g., a bucket) where aldehydes must be neutralized before they are placed into a sewer system that may discharge to a POTW or into navigable waters. Solids contaminated with aldehydes (e.g., dirt, rags, or gloves, etc.) may be neutralized by directly adding the neutralizer to the solids or by placing the solids into a container with the neutralizer and, optionally, water.

Thus another embodiment of the invention relates to a system for neutralizing an α-hydrogen-free aldehyde and making the aldehydes less toxic comprising:

a container;

a source of α-hydrogen-free aldehyde without α-hydrogen selected from the group consisting of o-phthalaldehyde, formaldehyde and mixtures thereof directed to the container; and

a source of a base directed to the container to yield treated aldehydes of lower toxicity than the untreated aldehydes.

Additionally the system may further comprise a source of a pH adjusting material to adjust the pH of the treated aldehyde.

The source of materials suitable for use in conjunction with the systems of this invention are the same as disclosed above in the discussion relating to the methods of this invention. Additionally, the system may contain controls on any of the sources added to the container to achieve the treated aldehyde having a LC₅₀ greater than 500 mg/L, or any other desired non-toxicity level.

### EXAMPLES

Unless specified, all the reactions were performed at room temperature and concentrations are expressed on a w/v % basis except as noted and except when reference is made to 0.55% (w/w%) OPA from CIDEX® OPA Solution wherein this solution is expressed in a weight to weight basis.

The method used to evaluate the extent of neutralization was based on the visual examination of color of the solution (“Color Visualization”). Glycine solution (1%) was used to detect the presence of OPA. The appearance of any green color or dark green or black green is a good indication of the presence of OPA. If only one aldehyde group was present (if the other reacted with an oxidant), other color would display upon adding glycine, such as yellow, yellowish orange or orange or even reddish colors. Although the darkness of the green-flavored color of the Schiff s base formed between glycine and OPA is good indication of OPA level one has to keep in mind that the Schiff s base could be oxidized to cause darker color. Caution must be taken where comparison is needed in these situations. Although HPLC analysis is an ultimate tool for the analysis of di-aldehyde remaining, we found that the above estimation is quite sufficient for our purpose.

### Example 1

### OPA+NaOH

In a 20 mL scintillation vial with 10.0 mL CIDEX® OPA Solution (0.55% OPA), 1.0 mL of 1.0N sodium hydroxide (molar ratio NaOH:OPA=2.44:1) was added and the solution was allowed to stand overnight (16 hrs) at room temperature. There was no color change observed and the solution appeared to be exactly the same as that of untreated CIDEX® OPA Solution.

### Example 2

### OPA+NaOH+Glycine

0.2 mL 1% glycine was added to 1.0 mL of the reacted solution from example 1 and allowed to stand for 1 hr, a yellowish-orange color was developed quickly and stabilized. Example 3. (OPA +Glycine) 0.2 mL of 1% glycine was added to 1.0ML of 0.55% OPA Solution and allowed to stand for 1 hr. As expected, the OPA Solution gave a black color quickly as compared to the yellowish-orange color from treated solution of Example 2. By comparing the results of Examples 2 and 3, NaOH is effective to neutralize OPA.

### Example 4

### Effect of Mole Ratio

In this example, the same procedure was used in Example 1 and a series of reactions were carried out with differing amounts of sodium hydroxide. Vial c has the same solution as described in Example 1. After the reaction, 1.mL of the solution from each of the solutions was mixed with 0.2 mL 1% glycine and 5 minutes were allowed for any color to develop (Table 2). Referring to Table 2, as the amount of NaOH increases (>2.0 mL), the final color of the solutions becomes lighter, indicating that more of the OPA is being neutralized.

TABLE 2
Comparison of Different Amount of Sodium Hydroxide

| Reaction vials | a | b | c | d |
|---|---|---|---|---|
| NaOH (1 N) Vol. (mL) | 0.1 | 0.5 | 1.00 | 2.00 |
| OPA (0.55% or 0.041 M) Vol. | 10.0 | 10.0 | 10.0 | 10.0 |
| (mL) | | | | |
| Mole ratio NaOH:OPA | 0.24 | 1.22 | 2.44 | 4.88 |
| DI Water (mL) added to make | 1.9 | 1.50 | 1.00 | 0.00 |
| Vols. Equal | | | | |
| Color Visualization | Dark | Green | Yellowish- | Light |
| | green | | orange | pink |

### Example 5

### pH Adjustment of the OPA Neutralized Solution Method 1: with 10% Hydrochloric Acid)

The pH of the neutralized solutions were shown to be basic and understandably the value of the pH depends on the amount of the base used. The pH of the final solution could be decreased easily with 10% hydrochloric acid. Examples are shown in Table 3. The pH was determined with pH test paper.

TABLE 3
pH of OPA Neutralized Solution Adjusted with Hydrochloric Acid

| 10% HCl added (mL) to | |
|---|---|
| 1.0 mL solution | pH |
| 0 | 11 |
| 0.02 | 9 |
| 0.04 | 8 |
| 0.06 | 6 |
| 0.2 | 3 |

### Example 6

### pH Adjustment of the OPA Neutralized Solution Method 2: with Glycine

The Neutralized solution was basic having pH 11. The pH could also be decreased easily with 1% glycine. Examples are shown in Table 4. The pH was determined with pH test paper.

TABLE 4
pH of OPA Neutralized Solution Adjusted with 1% Glycine

| 1.0% Glycine added (mL) to | |
|---|---|
| 1.0 mL solution | pH |
| 0 | 11 |
| 1 | 10 |
| 2 | 9 |
| 3 | 8 |

The advantages to use amino acid, such as glycine, are that: (1) amino acids neutralize excess of base as demonstrated in Table 4; (2) amino acids also neutralize and remaining free aldehyde to form Schiff's base; and (3) some color may develop after adding glycine which indicates either not enough NaOH is added or too much OPA is used.

Alternatively, acid salts of amino acids can also be used. These include glycine hydrochloride, glycine bisulfate, histidine monohydrochloride, histidine dihydrochloride, lysine dihydrochloride, lysine sulfate, or any other amino acid hydrochloride. In that case, much smaller amount will be needed to adjust the pH. At the same time, it can also neutralize any remaining aldehydes. Glycine hydrochloride is preferred for this purpose.

### Example 7

### Fish tests

CALIFORNIA CODE REGS (“CCR”) Title 22-Fathead Minnow Hazardous Waste Screen Bioassay.

The following experiments were conducted to determine whether the aldehydes neutralized by the basic compound, NaOH, were hazardous under the above Californian regulation, except the more stringent concentration level of 750 mg/l was used instead of the less stringent 500 mg/l concentration of the Californian regulation.

(a) A solution of 50% sodium hydroxide (64.03g) was added to fresh 0.55% OPA (IL), stirred to mix and stood at room temperature for 58 hours. The mole ratio of OPA to sodium hydroxide was 1:19.52. The pH of the solution was about 13. The solution was then neutralized with 10% hydrochloric acid to pH 7.0. The solution is colorless. Test results indicated all twenty fish survived the challenge with 750 mg/L concentration in 96 hours.

(b) Repeat of (a) with Final Solution pH of 8.0.

A solution of 50% sodium hydroxide (64.03g) was added to fresh 0.55% OPA (1L), stirred to mix and stood at room temperature for 58 hours (OPA to sodium hydroxide mole ratio=1:19.52). The solution was neutralized with 10% hydrochloric acid to pH 8.0. Test results indicated all twenty fish survived the challenge with 750 mg/L concentration in 96 hours.

(c) The Same Test in (a) was Repeated with Half Amount of Base.

A solution of 50% sodium hydroxide (32.01g) was added to fresh 0.55% OPA (1L), stirred to mix and allowed to stand at room temperature for 58 hours (OPA to sodium hydroxide mole ratio=1:9.76). The solution was neutralized with 10% hydrochloric acid to pH 7.0. Test results indicated all twenty fish survived the challenge with 750 mg/L concentration in 96 hours.

(d) Repeat of (c) with Final Solution pH of 8.0.

A solution of 50% sodium hydroxide (32.01 g) was added to fresh 0.55% OPA (1L), stirred to mix and allowed to stand at room temperature for 58 hours (OPA to sodium hydroxide mole ratio=1:9.76). The solution was neutralized with 10% hydrochloric acid to pH 8.0. Test results indicated all twenty fish survived the challenge with 750 mg/L concentration in 96 hours.

(e) Same as (c) was with Final pH of 8.5.

A solution of 50% sodium hydroxide (32.01 g) was added to fresh 0.55% OPA (1L), stirred to mix and stood at room temperature for 58 hours (OPA to sodium hydroxide mole ratio=1:9.76). The solution was neutralized with 10% hydrochloric acid to pH 8.5. Test results indicated all twenty fish survived the challenge with 750 mg/L concentration in 96 hours.

(f) Same as (c) with Final pH of 9.0.

A solution of 50% sodium hydroxide (32.01 g) was added to fresh 0.55% OPA (IL), stirred to mix and stood at room temperature for 58 hours (OPA to sodium hydroxide mole ratio=1:9.76). The solution was neutralized with 10% hydrochloric acid to pH 9.0. Test results indicated all twenty fish survived the challenge with 750 mg/L concentration in 96 hours.

Thus, the foregoing fish tests show that the methods and systems of this invention substantially exceed the non-toxicity requirements of CCR Title 22.

In the preceding detailed description, the invention is described with reference to specific embodiments thereof. It will, however, be evident that various modifications and changes may be made thereto without departing from the broader spirit and scope of the invention as set forth in the claims. The specification and drawings are, accordingly, to be regarded in an illustrative rather than a restrictive sense.

What is claimed is:

1. A method for making a neutralized aldehyde of lessened toxicity comprising the steps of:
c) providing an α-hydrogen-free aldehyde ; and
d) contacting the aldehyde with an effective amount of a base to render the treated aldehyde as neutralized and less toxic compared with the untreated aldehyde.

2. The method of claim 1 wherein the aldehyde comprises aldehydes selected from the group consisting of o-phthalaldehyde, formaldehyde and mixtures thereof.

3. The method of claim 1, wherein the base comprises at least one hydroxide group.

4. The method of claim 3, wherein the base is selected from the group consisting of sodium hydroxide, potassium hydroxide, calcium hydroxide, lithium hydroxide, magnesium hydroxide, ferric hydroxide, aluminum hydroxide and mixtures thereof.

5. The method of claim 3, wherein the at least one hydroxide group is produced from a chemical reaction.

6. The method of claim 5, wherein the chemical reaction includes at least one chemical reacts with water, wherein the at least one chemical is selected from the group consisting of metallic lithium, metallic sodium, metallic potassium, metallic magnesium, metallic calcium, sodium hydride, potassium hydride, magnesium hydride, calcium hydride, lithium hydride, sodium methoxide, sodium ethoxide, potassium methoxide, potassium ethoxide and mixtures thereof.

7. The method of claim 3, wherein the base is sodium hydroxide.

8. The method of claim 7, wherein the molar ratio of sodium hydroxide to o-phthalaldehyde is at least about 2.4:1.

9. The method of claim 1, wherein said the treated aldehyde has a pH, and the method further comprising adjusting the pH of the treated aldehyde.

10. The method of claim 9, wherein the pH of the treated aldehyde is adjusted by adding an acid.

11. The method of claim 10, wherein the acid is an organic acid or an inorganic acid.

12. The method of claim 11, wherein the organic acid is selected from the group consisting of amino acids, formic acid, acetic acid, propionic acid, butyric acid, benzoic acid, and mixtures thereof.

13. The method of claim 11 wherein the inorganic acid is selected from the group consisting of hydrochloric acid, sulfuric acid, phosphoric acid, potassium dihydrogen phosphate, nitric acid and mixtures thereof.

14. The method of claim 9, wherein the pH of the treated aldehyde is adjusted by a buffer.

15. The method of claim 9, wherein the pH of the treated aldehyde is adjusted by adding water.

16. The method of claim 9, wherein the pH of the treated aldehyde is adjusted by adding an acid salt of an amino acid.

17. The method of claim 16, wherein the acid salt of the amino acid is selected from the group consisting of glycine hydrochloride, glycine bisulfate, histidine monohydrochloride, histidine dihydrochloride, lysine dihydrochloride, lysine sulfate, or any other amino acid hydrochloride and mixtures thereof.

18. The method of claim 9, wherein the pH of the treated aldehyde is adjusted to 9 or lower.

19. The method of claim 1, wherein the aldehyde is neutralized at room temperature.

20. The method of claims 1-19, wherein the treated aldehyde has a LC₅₀ greater than 500 mg/L.

21. A system for neutralizing an α-hydrogen-free aldehyde and making the aldehydes less toxic comprising:
a container;
a source of α-hydrogen-free aldehyde selected from the group consisting of o-phthalaldehyde, formaldehyde and mixtures thereof directed to the container; and
a source of a base directed to the container to yield treated aldehydes of lower toxicity than the untreated aldehydes.

22. The system of claim 21, wherein the base comprises at least one hydroxide group.

23. The system of claim 22, wherein the base is selected from the group consisting of sodium hydroxide, potassium hydroxide, calcium hydroxide, lithium hydroxide, magnesium hydroxide, ferric hydroxide, aluminum hydroxide and mixtures thereof.

24. The system of claim 22, wherein the at least one hydroxide group is produced from a chemical reaction.

25. The system of claim 24, wherein the chemical reaction includes at least one chemical that reacts with water, wherein the at least one chemical is selected from the group consisting of metallic lithium, metallic sodium, metallic potassium, metallic magnesium, metallic calcium, sodium hydride, potassium hydride, magnesium hydride, calcium hydride, lithium hydride, sodium methoxide, sodium ethoxide, potassium methoxide, potassium ethoxide and mixtures thereof.

26. The system of claim 22, wherein the base is sodium hydroxide.

27. The system of claim 26, wherein the molar ratio of sodium hydroxide to o-phthalaldehyde is at least about 2.4:1.

28. The system of claim 22 further comprising a source of pH adjusting material to adjust the pH of the treated aldehyde.

29. The system of claim 28, wherein the source of pH adjusting material is an acid.

30. The system of claim 29, wherein the acid is an organic acid or an inorganic acid.

31. The system of claim 30, wherein the organic acid is selected from the group consisting of amino acids, formic acid, acetic acid, propionic acid, butyric acid, benzoic acid, and mixtures thereof.

32. The system of claim 30 wherein the inorganic acid is selected from the group consisting of hydrochloric acid, sulfuric acid, phosphoric acid, potassium dihydrogen phosphate, nitric acid and mixtures thereof.

33. The system of claim 28, wherein the source of pH adjusting material is a buffer.

34. The system of claim 28, wherein the source of pH adjusting material is water.

35. The system of claim 28, wherein the source of pH adjusting material is an acid salt of an amino acid.

36. The system of claim 35, wherein the acid salt of the amino acid is selected from the group consisting of glycine hydrochloride, glycine bisulfate, histidine monohydrochloride, histidine dihydrochloride, lysine dihydrochloride, lysine sulfate, or any other amino acid hydrochloride and mixtures thereof.

37. The system of claim 28, wherein the sources of pH adjusting material added to the container are controlled to achieve the treated aldehyde having the pH 9 or lower.

38. The system of claims 21 to 37, wherein the sources added to the container are controlled to achieve the treated aldehyde having a LC₅₀ greater than 500 mg/L.
